(19) United States
(12) Patent Application Publication
(10) Pub. No.: US 2018/0320820 A1
(43) Pub. Date: Nov. 8, 2018

(54) ERGONOMIC SYSTEM FOR AND METHOD OF DECREASING STRESS TO NECK AND SHOULDERS OF MOBILE DEVICE USERS

(71) Applicant: PAMELA SCOTT, LEE'S SUMMIT, MO (US)

(72) Inventor: PAMELA SCOTT, LEE'S SUMMIT, MO (US)

(21) Appl. No.: 15/974,464

(22) Filed: May 8, 2018

Related U.S. Application Data
(60) Provisional application No. 62/503,178, filed on May 8, 2017.

(51) Int. Cl. F16M 13/04; H04M 1/04

(52) U.S. Cl. CPC F16M 13/04; F16M 13/022; H04M 1/04

(57) ABSTRACT

A system for and method of reducing or eliminating neck and back pain is provided. The system includes various features for encouraging good posture while using mobile devices. A support assembly is configured to selectively hold the mobile device at or slightly below eye level and a support pillow is configured to provide support for arms of the user during selective engagement with the mobile device. In this way, the arms, shoulders, and back of the user do not become fatigued and the user is prevented or otherwise discouraged from lowering the mobile device. Adjustable stanchions of the support assembly facilitate adjusting the height and position of the mobile device to accommodate users of different heights and to accommodate different viewing preferences while still encouraging improved posture for each user.

### CROSS-REFERENCE TO RELATED APPLICATIONS

This application claims priority pursuant to 35 U.S.C. 119(e) to co-pending U.S. Provisional Patent Application Ser. No. 62/503,178, filed May 8, 2017, the entire disclosure of which is incorporated herein by reference.

### FIELD OF THE INVENTION

The present invention relates generally to ergonomic devices. More specifically, the present invention is concerned with a system for and methods of decreasing physical stress and strain to necks and shoulders associated with use of mobile devices.

### BACKGROUND OF THE INVENTION

The increased use of smart phones and other mobile devices has led to a dramatic increase in neck and back problems for users. This is, at least in part, due to the natural tendency of many users to hold their mobile devices down against their abdomens. Other users tend to lay their mobile devices down on a flat surface, such as a table surface. In either case, the user's head must be tilted downward to see the screen of the mobile device, requiring the user to maintain poor posture while viewing the screen. As screen time in general continues to increase and as screen time for mobile devices, specifically, continues to take the place of traditional screen time associated with television and computers (which are generally positioned at or near eye level allowing the user to maintain good posture), more and more users of mobile devices are spending longer and longer periods of time maintaining poor posture, thereby increasing neck and back problems. Furthermore, the increase in use of mobile devices has been accompanied by a very concerning increase in poor posture, neck, and back problems with children and young adults.

It has been suggested that many of the neck and back problems of mobile device users can be solved by holding mobile devices up generally in line with or slightly below the user's line of sight. By holding a mobile device at or near eye level, the user's head is not required to be tilted downward to see the screen of the mobile device, allowing the user to maintain good posture while viewing the screen. Unfortunately, while holding a mobile device up for short periods of time is feasible, many users find themselves slowly lowering their device and/or forgetting to raise the device in the first place. Consequently, it would be beneficial to have a system for and method of assisting mobile device users in maintaining their mobile devices at or near eye level and/or for reminding such users to hold their mobile devices in such a position in the first place. Furthermore, holding a mobile device up at eye level requires the user to lift their arms, causing the arms to tire and/or the shoulders to hurt. Consequently, it would further be beneficial to have a system for and method of supporting a user's arms to reduce fatigue and other ailments.

### SUMMARY OF THE INVENTION

The present invention comprises a support assembly for supporting a mobile device and a support pillow for supporting a user's arms. In some embodiments, the support assembly is selectively coupled relative to the support pillow, thereby facilitating selective engagement with the mobile device by the user.

In some embodiments, the support assembly includes one or more adjustment feature for adjusting the position of the mobile device relative to the support pillow. In this way, the present invention can be adjusted to accommodate use of the mobile device by one or more user in one or more situations. For instance, a first user may be taller than a second user, thereby requiring the mobile device to be positioned higher for the first user than for the second user. As another example, a first user may desire the mobile device be moved closer to the user's face when viewing sensitive information and/or when bright background lighting makes it difficult to view images depicted on the screen of the mobile device. As yet another example, a first or second user may desire the mobile device be moved further from each user's face when both users are viewing the same images depicted on the screen and/or when background lighting is low such that lighting from the screen appears bright in comparison.

The support assembly comprises a carriage assembly for selectively holding the mobile device. In some embodiments, the carriage assembly is moveable between an open configuration and a closed configuration. In the open configuration, the carriage assembly is configured to selectively receive the mobile device. In some embodiments, moving the carriage assembly towards the closed configuration causes the carriage assembly to engage with the mobile device, thereby securing the mobile device relative to the carriage assembly. In some such embodiments, the carriage assembly includes one or more biasing member for biasing the carriage assembly towards its closed configuration.

The support assembly further comprises one or more stanchion that is configured to support the carriage assembly. In some embodiments, the carriage assembly is configured to slide along a length of the stanchion, thereby allowing a user to adjust the position of the carriage assembly. In other embodiments, the carriage assembly is secured at or near a distal end of an adjustable stanchion such that a user is able to adjust the position of the mobile device by adjusting the stanchion.

Some embodiments of the present invention include an adjustable stanchion extending from a support pillow, a distal end of the adjustable stanchion being configured to support a mobile device. In some embodiments, the adjustable stanchion includes telescoping members, thereby enabling a user to adjust a position of the mobile device relative to the support pillow by adjusting a height of the stanchion. In this way, the user is able to adjust the height of the mobile device so as to be at or slightly below eye level.

In some embodiments, the support pillow defines a first aperture for receiving a first end of a first stanchion of a support assembly of the present invention, thereby allowing the support assembly to engage with the support pillow. In some embodiments, the support assembly is configured to disengage with the support pillow by removing the first end of the first stanchion from the first aperture of the support pillow. In some embodiments, the support pillow defines an interior volume that is configured to selectively receive all or part of the support assembly when the support assembly is disengaged from the support pillow. In this way, the support assembly can be stored for future use. In other embodiments, the support pillow includes one or more other feature, such as a clip or a strap, for selectively securing the support assembly to the support pillow when the support assembly is disengaged from the support pillow.

In some embodiments, a proximal end of the first stanchion is rotatably secured to the support pillow, thereby facilitating adjusting an angle of the first stanchion relative to the support pillow. In other embodiments, the support pillow includes a first receptacle extending from the first aperture, the first receptacle being configured to receive a portion of the first end of the first stanchion. In some such embodiments, the first receptacle is pivotally coupled to the support pillow, thereby facilitating adjusting an angle of the first stanchion relative to the support pillow.

In some embodiments, the first stanchion is moveable between a first orientation and a second orientation. In still other embodiments, the first stanchion is moveable between the first orientation and a third orientation. In some embodiments, one or more feature of the support pillow prevents or otherwise inhibits the first stanchion from moving beyond the first, second, and/or third orientations. In some such embodiments, the first aperture is configured to facilitate movement of the first stanchion between its first, second, and/or third orientations while preventing or inhibiting the first stanchion from moving beyond the first, second, and/or third orientations.

In some embodiments, the support pillow defines a second aperture for receiving a first end of a second stanchion of the support assembly of the present invention, thereby providing extra support for the mobile device. In other embodiments, the second stanchion provides support for a second mobile device.

In some embodiments, a proximal end of the second stanchion is rotatably secured to the support pillow, thereby facilitating adjusting an angle of the second stanchion relative to the support pillow. In other embodiments, the support pillow includes a second receptacle extending from the second aperture, the second receptacle being configured to receive a portion of the first end of the second stanchion. In some such embodiments, the second receptacle is pivotally coupled to the support pillow, thereby facilitating adjusting an angle of the second stanchion relative to the support pillow. In some embodiments, the first and second receptacles are secured together such that they are configured to rotate in unison, thereby causing the first and second stanchions to rotate in unison. In other embodiments, the first and second receptacles are independent of each other, thereby allowing the first and second stanchions to rotate independent of each other.

In some embodiments, the second stanchion is moveable between a first orientation and a second orientation. In still other embodiments, the second stanchion is moveable between the first orientation and a third orientation. In some embodiments, one or more feature of the support pillow prevents or otherwise inhibits the second stanchion from moving beyond the first, second, and/or third orientations. In some such embodiments, the second aperture is configured to facilitate movement of the second stanchion between its first, second, and/or third orientations while preventing or inhibiting the second stanchion from moving beyond the first, second, and/or third orientations.

In some embodiments, the first and/or second stanchion is generally perpendicular to a top surface of the support pillow in its respective first orientation. In other embodiments, the first and/or second stanchion is angled fifteen degrees away from the user when the respective stanchion is in its respective second orientation. In still other embodiments, the first and/or second stanchion is angled fifteen degrees towards the user when the respective stanchion is in its respective third orientation.

In some embodiments, the support pillow includes one or more support surface for selective engagement with one or more arm and/or elbow of a user, thereby providing a means of supporting the user's arm as the user engages with the mobile device. In some embodiments the support surface is a padded surface that is configured to maximize comfort for the user. In other embodiments, the support surface is a flat surface that is configured to maximize versatility of the support pillow. In some such embodiments, the flat support surface is a white board, a chalk board, or some other erasable surface for facilitating jotting down one or more quick note. In other such embodiments, the flat support surface is a generally hard surface that is configured to serve as a writing surface. In still other such embodiments, the flat support surface is configured to serve as a tray for food, snacks, projects, or the like.

In some embodiments, the support pillow includes a first surface having a first configuration and an opposed second surface having a second configuration, the support pillow being configured to be selectively used with the first or second surface facing upwards. In some such embodiments, the first and second surfaces each define one or more aperture and/or each include one or more other feature for selectively engaging with one or more stanchion. In other embodiments, the support pillow includes a first, second, third, fourth, and/or some other number of other edges that are configured to interface and/or be positioned relative to an abdomen of one or more other user. In some such embodiments, one or more aperture is positioned relative to one or more side of the pillow, thereby accommodating users of different size, shapes, and preferences. In this way, the support pillow and support assembly can be used together in a variety of orientations and configurations to accommodate a variety of needs and preferences.

The present invention further comprises a method of reducing or eliminating back pain. In some embodiments, the method includes positioning a pillow of a text neck eliminator system of the present invention onto a lap of a user of a mobile device. The mobile device is then secured to a carriage assembly or other feature of the text neck eliminator system such that the mobile device is supported by the text neck eliminator system. In some embodiments, the method further includes adjusting the position of the mobile device by adjusting one or more feature of the text neck eliminator system. In this way, the user is able to position a screen of the mobile device at or slightly below eye level of the user, thereby reducing the likelihood that the user will later reposition the mobile device below eye level, thereby reducing the risk of future neck and back problems associated with looking down at a phone.

In some embodiments, the method of the present invention further includes positioning elbows of the user on a support surface of the text neck eliminator system, thereby facilitating selective user engagement with the mobile device by one or more hand of the user. In this way, any moment generated from extending the user's arm up and away from the user's torso is reacted by the support surface, not by the user's arms, shoulders, and back. In this way, fatigue and pain associated with raising and/or extending the user's arms for selective engagement with the mobile device is eliminated or otherwise reduced.

In some embodiments, selective engagement with the mobile device by the user results in the user applying a generally outward force onto the mobile device. In some such embodiments, one or more stanchion of the text neck eliminator system provides a reactive force equal to and opposite to the generally outward force. In some such embodiments, the one or more stanchion serves as a cantilever beam supported by the support pillow. In this way, the generally outward force generates an overturning moment reacted by the support pillow. In some such embodiments, a generally downward force applied to the support pillow by the elbows and/or arms of the user balances out the overturning moment generated by the generally outward force, thereby providing additional support for mobile device.

In some embodiments, the support pillow includes one or more padded feature for accommodating prolonged engagement by an elbow or other portion of a user's arm. In this way, fatigue to the user's elbow and/or arm is eliminated or otherwise reduced. In some embodiments, the padded feature is detachable from the support pillow. In some such embodiments, the support pillow defines an interior area for storing the padded features when not in use. In other embodiments, the padded feature is moveable between a stowed configuration and a deployed configuration. In the deployed configuration, the padded feature is positioned for selective engagement by a user. In stowed configuration, the padded feature is at least partially concealed and/or is at least partially folded into one or more feature of the support pillow, thereby facilitating storage of the support pillow. In some such embodiments, the padded feature is moveable from the stowed configuration to the deployed configuration by folding the padded feature out of the support pillow and/or out of one or more other feature of the support pillow, such as a table of the support pillow. In some embodiments, the padded feature includes a gel-type substance for added comfort, durability, and versatility.

In some embodiments, the present invention further includes one or more other feature. In some embodiments, the present invention includes a wired or wireless charger for selectively charging one or more mobile device. In other embodiments, the present invention includes a wired or wireless remote, such as a remote for operating one or more function of the mobile device. In still other embodiments, the present invention includes one or more wired or wireless speaker, such as one or more Bluetooth-enabled speaker. In yet other embodiments, the present invention includes a cup holder that is moveable between a stowed configuration for storage and a deployed configuration for holding one or more cup or other item. In still yet other embodiments, the support pillow and/or the support assembly defines one or more storage compartment for storing one or more adaptor or other feature associated with the mobile device.

In some embodiments, the present invention is configured as and/or is configurable to be a laptop desk for supporting one or more laptop computer or other device in addition to supporting one or more mobile device. In other embodiments, the present invention is configured as and/or is configurable to be a game table having one or more controls for controlling one or more function of a game. In still other embodiments, one or more leg is selectively secured to and/or selectively extends from the support pillow such that the present invention is configured as and/or selectively configurable as a fold-out standing desk. In some embodiments, one or more leg is a telescoping leg and/or is otherwise adjustable relative to the support pillow and/or one or more other surface, thereby accommodating a variety of surface requirements and/or preferences. In some embodiments, one or more surface is adjustable in height, length, width, position, orientation, or otherwise.

In some embodiments, the support pillow is configured to rest on and/or otherwise engage with one or more leg of a user when the user is in a sitting position. In this way, the support pillow is configured to be supported by a person's lap. In other embodiments, the support pillow is configured to receive one or more elbow or other portion of one or more of the user's arms. In this way, the support pillow is configured to provide an arm rest for the user. In some embodiments, the support pillow and/or support assembly includes one or more adjustment feature for accommodating users of different shapes and sizes. In some such embodiments, a first embodiment of the present invention is sized proportionally so as to accommodate use by small children. In other such embodiments, a second embodiment of the present invention is sized proportionally so as to accommodate use by adults.

It will be appreciated that in some embodiments the support pillow does not include a cushion or support pillow of any sort. In some such embodiments the support defines a flat working surface, such as a flat working surface of a table or desk. In some embodiments, the support pillow is not a pillow at all but instead is a tray, a desktop, or other device having a surface that is capable of supporting one or more arm of a user.

It will further be appreciated that in some embodiments the support pillow includes a plurality of legs for supporting the support pillow above a floor or other surface. In some embodiments, the legs are hingedly coupled to the support pillow such that each leg is rotatable between a stowed configuration for storage and a deployed configuration for selective engagement with a surface, a structure, or the user. In some embodiments, one or more leg is adjustable in length and/or includes one or more feature for selectively engaging with one or more structure, such as a chair or lectern, or with one or more feature of a user, such as a leg of a user. In this way, the support assembly of the present invention is capable of being utilized in a variety of different locations, regardless of whether the user is in a sitting, standing, kneeling, or other position.

The foregoing and other objects are intended to be illustrative of the invention and are not meant in a limiting sense. Many possible embodiments of the invention may be made and will be readily evident upon a study of the following specification. Various features and subcombinations of invention may be employed without reference to other features and sub combinations.

What is claimed is:

1. A system for facilitating ergonomic use of mobile devices, the system comprising:
a support pillow for supporting one or more arm of a user; and
a support assembly extending from said support pillow, said support assembly being configured to support a mobile device,
wherein said support assembly comprises a carriage assembly for selectively holding the mobile device.

2. The system of claim 1, wherein said support assembly comprises an adjustable stanchion having telescoping members, thereby enabling the user to adjust a position of the mobile device relative to said support pillow.

3. The system of claim 2, wherein said support pillow includes a support surface defining a first aperture for receiving a first end of said adjustable stanchion, thereby allowing said adjustable stanchion to extend from said support pillow.

4. The system of claim 3, wherein said support assembly is configured to selectively disengage from said support pillow by removing said first end of said adjustable stanchion from said first aperture of said support surface.

5. The system of claim 3, wherein said support surface further defines a second aperture for receiving a first end of a second stanchion of said support assembly, thereby providing additional support for supporting the mobile device.

6. The system of claim 3, wherein said support surface further defines a second aperture for receiving a first end of a first stanchion of a second support assembly, thereby facilitating support of a second mobile device.

7. The system of claim 2, wherein a proximal end of said adjustable stanchion is secured to said support pillow such that a distal end of said adjustable stanchion is displaced from said support pillow, said carriage assembly being secured to said distal end of said adjustable stanchion.

8. The system of claim 7, wherein said adjustable stanchion is rotatably secured to said support pillow, thereby further enabling the user to adjust a position of the mobile device relative to said support pillow.

9. The system of claim 8, wherein said adjustable stanchion is moveable between a first orientation generally perpendicular to a top surface of the support pillow and a second orientation angled fifteen degrees away from the user.

10. The system of claim 8, wherein said adjustable stanchion is moveable between a first orientation generally perpendicular to a top surface of the support pillow and a third orientation angled fifteen degrees towards the user.

11. The system of claim 1, further comprising a plurality of speakers configured to be in digital or analog communication with the mobile device.

12. The system of claim 1, wherein said support pillow defines one or more storage area for selectively storing one or more accessory of the mobile device.

13. The system of claim 1, wherein the support pillow is configured to rest on a lap of the user.

14. The system of claim 1, further comprising a plurality of legs extending from the support pillow, each leg being configured for selective engagement with a floor, thereby supporting the support pillow above the floor.

15. The system of claim 1, further comprising a cup holder pivotally secured to the support pillow, the cup holder being moveable between a stowed configuration for storage and a deployed configuration for selectively holding a cup of the user.

16. A method of reducing or eliminating neck and back pain, the method comprising:
positioning a support pillow of a text neck eliminator system on a lap of a user of a mobile device;
securing the mobile device to a carriage assembly of a support assembly of the text neck eliminator system;
adjusting the position of the mobile device by adjusting a configuration of the support assembly, thereby positioning the mobile device at or slightly below eye level of the user; and
moving elbows of the user into engagement with the support pillow, thereby supporting arms of the user while facilitating selective user engagement with the mobile device by one or more hand of the user.

17. The method of claim 16, wherein selective engagement with the mobile device by the user results in the user applying a generally outward force onto the mobile device, wherein a stanchion of the text neck eliminator system provides a reactive force equal and opposite to the generally outward force.

18. The method of claim 17, wherein the generally outward force generates an overturning moment, the overturning moment being balanced by a downward force associated with the engagement of the user's elbows with the support pillow.

19. The method of claim 16, further comprising securing the support assembly to the support pillow by inserting a proximal end of a stanchion of the support assembly into an aperture defined by the support pillow.

20. The method of claim 16, wherein adjusting the position of the mobile device is accomplished by moving at least one telescoping member of an adjustable stanchion relative to at least one other telescoping member of the adjustable stanchion.
